(19) United States
(12) Patent Application Publication
(10) Pub. No.: US 2010/0193700 A1
(43) Pub. Date: Aug. 5, 2010

(54) SPECTRAL PHOTON COUNTING DETECTOR

(75) Inventors: Christoph Herrmann, Aachen (DE); Roger Steadman, Aachen (DE); Christian Baeumer, Hoerstel (DE); Guenter Zeitler, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/602,252

(22) PCT Filed: May 22, 2008
(86) PCT No.: PCT/IB2008/052029

§ 371 Date: Nov. 30, 2009

Related U.S. Application Data
(60) Provisional application No. 60/941,362, filed on Jun. 1, 2007.

(51) Int. Cl. G01T 1/17

(52) U.S. Cl. 250/395; 250/336.1

(57) ABSTRACT

An apparatus includes a scale factor determiner (236) that determines a count scale factor based on a measured count of a number detected photons for an energy threshold and an estimated actual count of the number of detected photons. The photons include poly-energetic photons detected by a radiation sensitive detector. The apparatus further includes a count sealer (136) that employs the count scale factor to scale measured counts of detected photons for different energy thresholds.

The present application generally relates to spectral photon counting detectors. While it is described with particular application to computed tomography (CT), it also relates to other applications in which it is desirable to energy-resolve detected photons having different energies.

A computed tomography (CT) system has included a radiation source that emits poly-energetic ionizing photons that traverse an examination region. Such a system has also included a radiation sensitive detector, located opposite the examination region from the radiation source that detects the photons that traverse the examination region. The detector has produced an electrical signal, such as a current or voltage, for each detected photon. The detector has also included electronics for energy-resolving the detected photons based on the electrical signals.

By way of example, a radiation sensitive detector has included a pulse shaper for processing an electrical current produced by a sensor to generate a voltage pulse having peak amplitude indicative of the energy of the detected photon. The detector has also included a discriminator that compares the amplitude of the voltage pulse with two or more thresholds that are set in accordance with different energy levels. The output of the discriminator for a threshold goes high when the pulse amplitude increases and crosses the threshold and low when the pulse amplitude decreases and crosses the threshold. For each threshold, a counter counts the rising edges. If two or more thresholds and corresponding counters are incorporated in the detector, an energy binner can energy-bin the counts in energy ranges or bins. Therefore, the detected photons have been energy resolved based on the binned data.

Unfortunately, the time between successive photon detections may result in pulse pile-up within the sensor, or the pulse shaper generates pulses that overlap. When pulses overlap, their amplitudes may combine so that the individual pulses are not readily discernable from the combination. As a consequence, the discriminator may not see the amplitude of a pulse cross a given threshold. In addition, the peak energy of a pulse may be shifted by the amplitude contribution of overlapping pulse. As a result, the energy distribution of the detected photons may be erroneously shifted.

Aspects of the present application address the above-referenced matters and others.

According to one aspect, an apparatus includes a scale factor determiner that determines a count scale factor based on a measured count of a number of detected photons for an energy threshold and an estimated actual count of the number of detected photons. The photons include poly-energetic photons detected by a radiation sensitive detector. The apparatus further includes a count scaler, which employs the count scale factor to scale measured counts of detected photons for different energy thresholds.

In another aspect, a radiation sensitive detector of an imaging system includes a counter that counts non-overlapping pulses indicative of detected x-ray photons for a plurality of energy thresholds and a count scaler that adjusts the count for each threshold for disregarded overlapping pulses. The count is adjusted based on an estimated count of detected photons having a minimum energy and a measured count of photons based on the count of non-overlapping pulses.

In another aspect, a method includes generating first and second pulses for a detected photon, wherein the first pulse has a peak amplitude indicative of the energy of the detected photon, and the second pulse has a peak amplitude indicative of whether the energy of the detected photon exceeds a minimum desired photon energy. In particular, the second pulse must allow for distinguishing x-ray induced hits in the sensor from false noise-induced signals. The method further includes counting the number of times the amplitude of non-overlapping first pulses exceeds a threshold for a plurality of different energy thresholds and disregarding overlapping first pulses, and counting the number of times the amplitude of the second pulses exceeds the minimum desired photon energy. The method further includes computing a scale factor by dividing the number of times the second pulses exceed the minimum desired photon energy by the number of times the non-overlapping first pulses exceed a lowest threshold of the plurality of different energy thresholds. The method further includes using the scale factor to adjust the count for each of the plurality of different energy thresholds.

Still further aspects of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

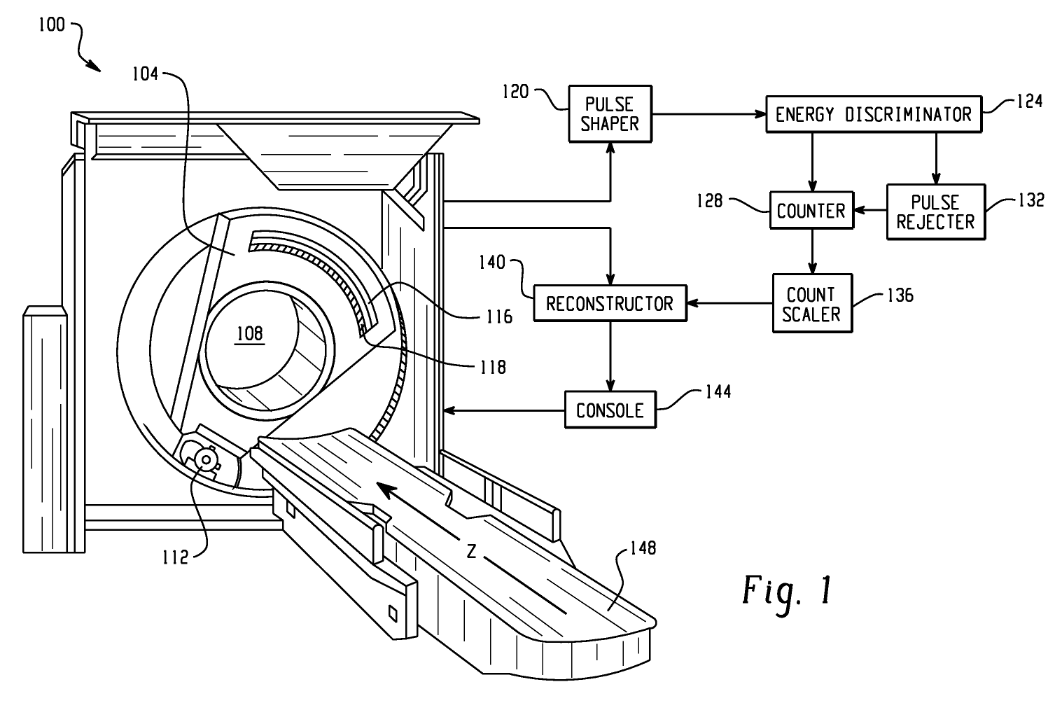

FIG. 1 illustrates an imaging system.

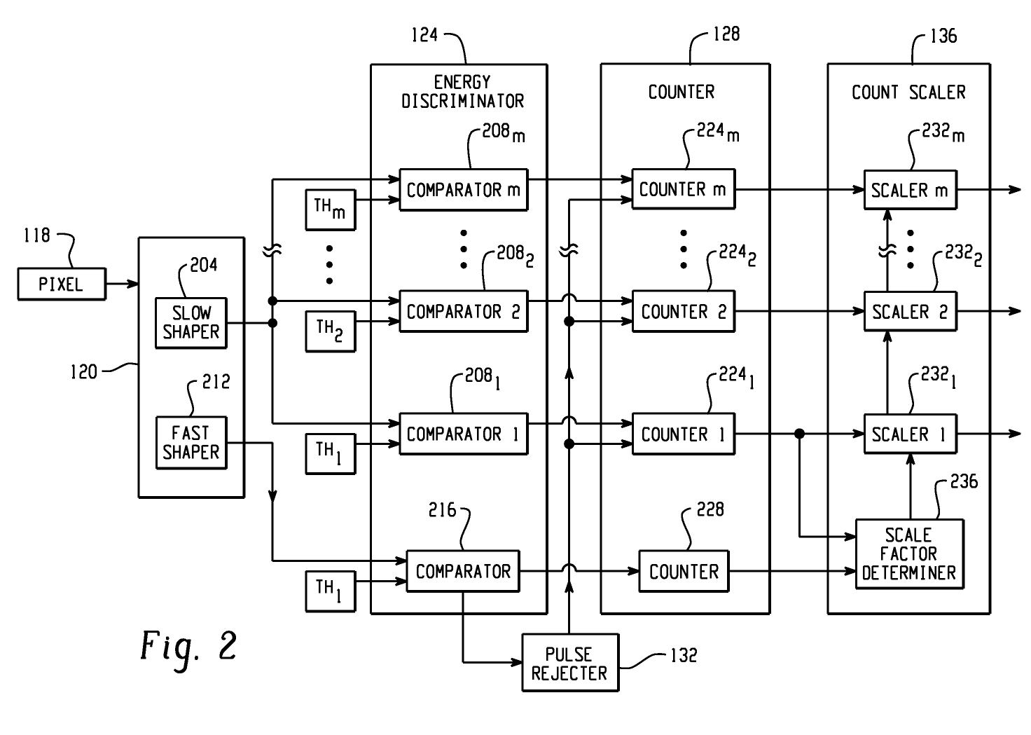

FIG. 2 illustrates a portion of the imaging system for adjusting a count of detected photons for a plurality of energy thresholds.

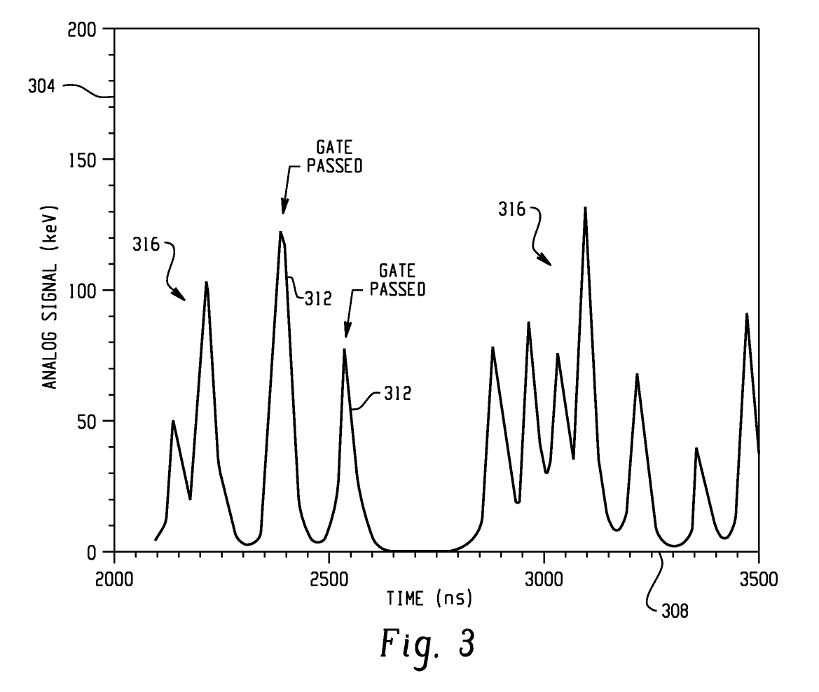

FIG. 3 illustrates a pulse gating technique.

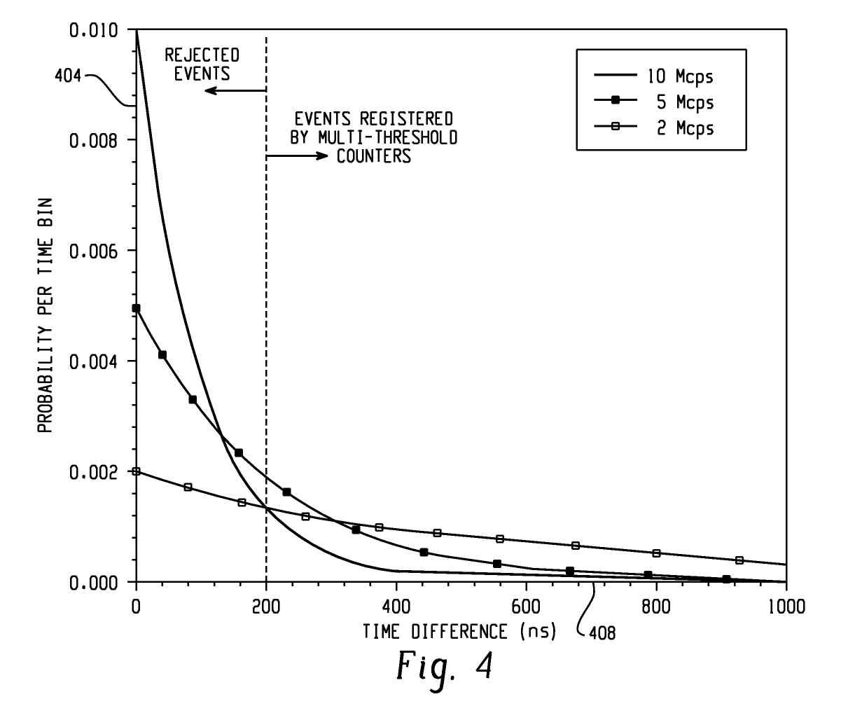

FIG. 4 illustrates a pulse gating technique.

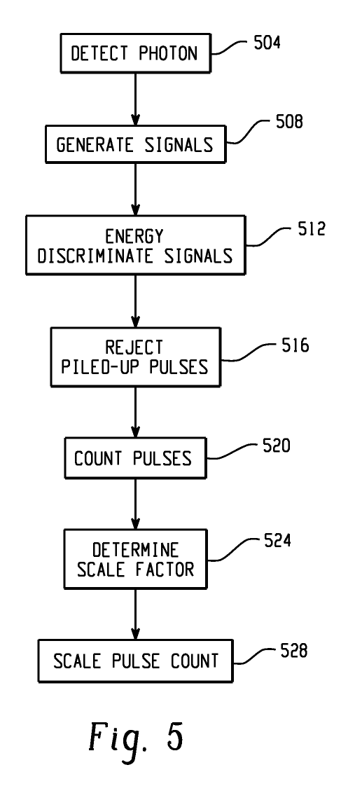

FIG. 5 illustrates a method.

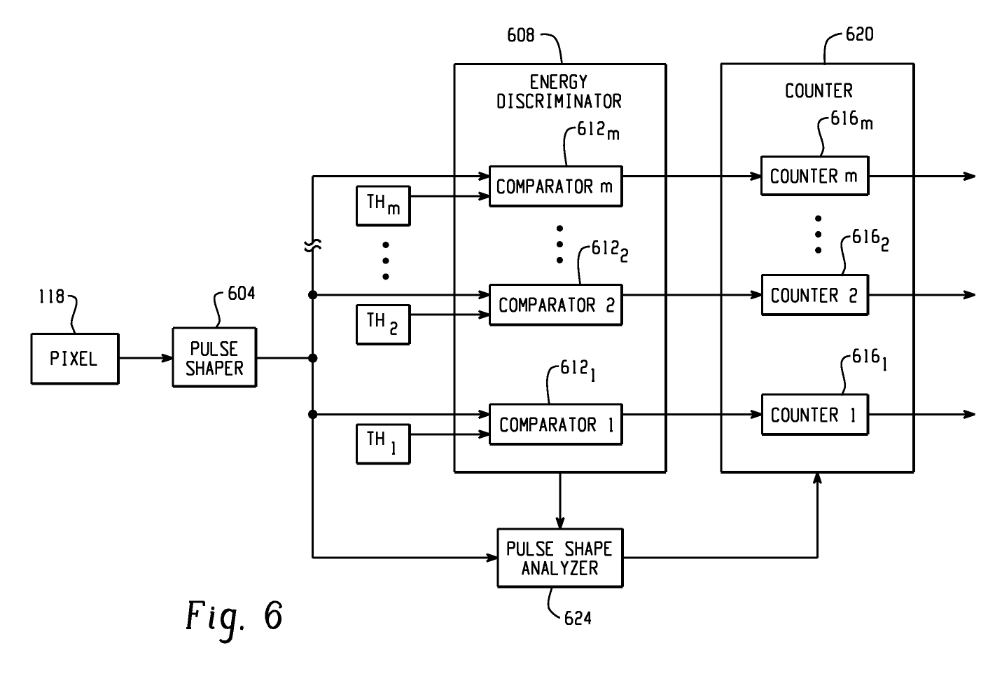

FIG. 6 illustrates a counting mode portion of the system.

With reference to FIG. 1, a computed tomography (CT) system 100 includes a rotating gantry portion 104 which rotates about an examination region 108 around a longitudinal or z-axis. An x-ray source 112, such as an x-ray tube, is supported by the rotating gantry portion 104 and emits a poly-energetic radiation beam that traverses the examination region 108.

A radiation sensitive detector 116 includes a pixel 118 that detects photons emitted by the source 112 over at least one hundred and eighty degrees plus a fan angle. The pixel 118 generates a corresponding electrical signal, such as electrical currents or voltages, for each detected photon. Examples of suitable sensors include direct conversion detectors (e.g., cadmium zinc telluride (CZT) based detectors) and scintillator-based sensors that include a scintillator in optical communication with a photosensor.

A pulse shaper 120 processes the electrical signal and generates one or more pulses such as voltage or other pulses indicative of the detected photon. As described in greater detail below, the pulse shaper 120 includes electronics for integrating charge during a first time interval to produce pulses with peak amplitudes indicative of the energy of the detected photons and electronics for integrating the charge during a second, relatively shorter time interval to produce pulses with peak amplitudes indicative of whether the energy of a detected photon exceeds a minimum desired energy.

An energy discriminator 124 energy-discriminates the pulses. This includes comparing the amplitudes of the generated pulses with one or more thresholds that respectively correspond to particular energy levels. The energy discriminator 124 produces an output signal, for each threshold, indicative of whether the amplitude increases and crosses the corresponding threshold and decreases and crosses the threshold. For instance, the output signal may include rising (or falling) edges when the amplitude increases and crosses the corresponding threshold and falling (or rising) edges when the amplitude decreases and crosses the corresponding threshold.

A counter 128 counts the rising (or falling) edges in the signals for each threshold. A pulse rejecter 132 rejects pulses, or gates the counter 128 so that the counter 128 disregards or otherwise does not count the rising (or falling) edges for undesired pulses such as piled-up pulses. The pulse rejecter 132 produces a gating signal based on the output of the energy discriminator 124.

A count scaler 136 scales or otherwise adjusts the count for the thresholds to account for disregarded pulses, which are not counted. In one instance, the count scaler 136 generates a count scaling factor for a threshold based on the measured count of detected photons for the threshold and an estimated total count of detected photons for the threshold, as described in greater detail below. The count scaler 136 employs the count scaling factor to scale the counts for the thresholds.

A reconstructor 140 selectively reconstructs the signals generated by the detector 116 based on the spectral characteristics of the signals.

An object support 148 such as a couch supports a patient or other object in the examination region 108. The object support 148 is movable so as to guide the object with respect to the examination region 108 when performing a scanning procedure.

A general purpose computer serves as an operator console 144. The console 144 includes a human readable output device such as a monitor or display and an input device such as a keyboard and mouse. Software resident on the console 144 allows the operator to control and interact with the scanner 100, for example, through a graphical user interface (GUI). Such interaction may include instructions for reconstructing the signals based on the spectral characteristics.

As discussed above, the count scaler 136 scales the measured counts to account for uncounted pulses. The following describes a non-limiting approach for determining a suitable count scaling factor κ that can be used to scale the measured counts.

The attenuation coefficient μ for a poly-energetic spectrum can be decomposed into different components. In one example, such components may include the attenuation coefficients of calcium and water. In another example, such components may include Photo-effect, Compton-effect and K-edge-material components. For the latter case, the attenuation coefficient μ can be decomposed as a function of Equation 1:

$$μ ( E , \vec{x} ) = \frac{1}{{E}^{3}} {a}_{1} ( \vec{x} ) + {f}_{KN} ( E ) {a}_{2} ( \vec{x} ) + {μ}_{Ke}^{*} ( E ) {ρ}_{Ke} ( \vec{x} ) . \qquad Equation 1$$

The spatial distribution a₁, a₂, ρ_{Ke} can be reconstructed from angular and spatial samplings. The line-integrals A₁:=∫a₁(\vec{x})d\vec{x}, A₂:=∫a₂(\vec{x})d\vec{x}, and A₃:=ρ_{Ke}(\vec{x})d\vec{x}, resulting from ∫μ(E,\vec{x})dE, can be obtained by solving a plurality of non-linear equations. This can be achieved through a Maximum Likelihood estimation or the like.

For m energy thresholds, the number of photons per energy bin Nₖ, wherein k=1 to m, in a frame is a function of Equation 2:

$${N}_{k} = {\int }_{{I}_{k}} {S}_{0} ( E ) {e}^{- \frac{1}{{E}^{3}} {A}_{1} - {f}_{KN} ( E ) {A}_{2} - {μ}_{Ke}^{*} ( E ) {A}_{3}} d E , \qquad Equation 2$$

wherein Iₖ represents the different energy windows and S₀ (E) describes the energy distribution of the source-detection system. S₀ (E) may be determined from the product of the tube energy spectrum and the detection efficiency of the x-ray sensor.

The measured number of photons per energy bin, Mₖ, may be less than Nₖ. This may be due to various reasons including piled-up pulses and/or disregarding, or not counting piled-up pulses. However, a relationship between Nₖ and Mₖ can be described through a count scaling factor κ as shown in Equation 3:

κ=Nₖ/Mₖ. Equation 3

FIG. 2 illustrates an example technique for determining and using the count scaling factor κ to scale Mₖ to approximate Nₖ. As shown, the pulse shaper 120 includes a slow shaper 204. The slow shaper 204 is configured to produce a pulse suitable for energy discrimination over a plurality of voltage thresholds THₖ by a plurality of comparators 208ₖ (k=1 to M). This may include integrating charge for a time interval of sufficient length such that the peak amplitude of the resulting pulse corresponds to the energy of the detected photon. This allows for optimizing the shape of the resultant pulses for photon energy characterization based on the set of thresholds THₖ.

A fast shaper 212 is configured to produce a pulse suitable for energy discrimination with respect to a desired energy threshold, which in this example is TH₁, or the lowest threshold used with the slow shaper 204. As such, the pulse can be generated during a second, relatively shorter integration interval compared to that used with the slow shaper 204. This allows for optimizing the resultant pulses for detecting pulses having energy greater than the desired energy threshold and obtaining an estimate of the total number of detected photons having energy greater than the threshold. Fine energy discrimination resolution is not needed since the slow shaper 204 produces pulses for energy-discriminating the pulses. In other embodiments, the energy threshold may be set to a baseline threshold, a minimum photon energy threshold, or other desired energy threshold.

The comparators 208ₖ receive the signals from the slow shaper 204 and compare the amplitudes of the received signals with the corresponding thresholds THₖ. Each of the comparators 208ₖ outputs a signal that includes a rising (or falling) edge each time the pulse amplitude increases and crosses its threshold THₖ and a falling (or rising) edge each time the pulse amplitude decreases and crosses its threshold THₖ.

The comparator 216 receives the signal from the fast shaper 212. Likewise, the comparator 216 compares the amplitude of the received signal with a threshold and outputs a signal that includes a rising (or falling) edge each time the pulse amplitude increases and crosses its threshold TH₁ and a falling (or rising) edge each time the pulse amplitude decreases and crosses its threshold TH₁.

The counter block 128 includes sub-counters 224ₖ (k=1 to m) that respectively count the rising (or falling) edges produced by the comparators 208ₖ, and a sub-counter 228 that counts the rising (or falling) edges produced by the comparator 216.

The pulse rejecter 132 receives the signal produced by the comparator 216 and produces a gating signal based on the received signal. If desired, the pulses produced by one or more of the comparators 208ₖ can also be used by the pulse rejecter 132. The pulse rejecter 132 employs this information to determine whether a pulse is a piled-up pulse. For a piled-up pulse, the pulse rejecter 132 conveys a gating signal to each of the counters 224ₖ, and the counters 224ₖ do not count the rising (or falling) edges. In the illustrated embodiment, the same gating signal is used with each of and similarly affects the counters 224ₖ so that none of the counters 224ₖ count rising (or falling) edges for a piled-up pulse.

A relatively stringent gating technique can be employed by the pulse rejecter 132. Briefly turning to FIG. 3, an example of suitable gating is illustrated. In FIG. 3, a first axis 304 represents the amplitude of the pulse and a second axis 308 represents time. In this example, the pulse rejecter 132 allows pulses 312, which can be suitably distinguished from preceding and succeeding pulses, to be counted by the counter 128. However, overlapping pulses, or pulses 316 that are not suitably distinguishable from preceding and succeeding pulses, are rejected and not counted by the counter 128.

Turning to FIG. 4, a technique for determining whether successive pulses are suitably distinguishable from each other is illustrated. In FIG. 4, a first axis 404 represents probability per time bin, and a second axis 408 represents the time difference Δt between consecutive pulses, according to Poisson statistics. In this example, three mean count rates 2, 5, and 10 millions counts per second (Mcps) are illustrated. As depicted, the time distribution of the Poisson process is such that some of the time two pulses are likely to have a relatively short distance between them and other times two pulses are likely to be well separated in time. In this example, gating is configured such that pulses separated by Δt<200 ns are rejected and pulses separated by Δt>200 ns are counted and contribute to Mₖ. It has to be understood that in this example a Δt of 200 ns is selected for explanatory purposes. In other embodiments, Δt may be greater or less than 200 ns.

Returning to FIG. 2, for each frame the counts from the counters 224ₖ are conveyed to respective scalers 232ₖ (k=1 to m). A scale factor determiner 236 receives the counts from the counter 224₁ and the counter 228. The count from the sub-counter 224₁ provides a measured count for TH₁, or M₁ and the count from the sub-counter 228 provides an estimate of the true count for TH₁, or N₁. A dead-time model or other technique may alternatively or additionally be used to estimate Nₖ.

From this information, the scale factor determiner 236 determines the count scale factor κ based on Equation 3 above. The scaler 232₁ uses this count scale factor κ to scale the count of counter 224₁. Since the gating signal affects the counters 224ₖ in a similar manner, the same count scale factor κ is used by the scalers 232₂-232ₘ to scale the counts of the counters 224₂-224ₘ. As such, the count scale factor κ can be employed as an energy-window independent correction. Alternatively, a count scale factor κ can be generated for each threshold.

The scaled counts can then be further processed, for example, energy-binned and variously reconstructed via the reconstructor 140. By stringently gating the counter to reject piled-up pulses and then scaling the counts as described above, an accurate energy distribution of detected photons can be obtained at high, as well as other, photon fluxes. Thus, a complete set of energy information for optimum spectral CT imaging at high, as well as other, rates can be obtained

Operation will now be described in connection with FIG. 5.

At 504, a photon is detected. At 508, pulses for energy-discriminating and counting the detected photon are generated. At 512, the pulses are energy discriminated using a plurality of thresholds corresponding to different desired energy levels. The results are conveyed to a counter for counting the number of times each threshold is crossed. At 516, piled-up pulses are also located based on the results. At 520, the pulses are counted.

This includes counting non-overlapped pulses and counting all pulses. At 524, a count scale factor κ is determined from the pulse counts. At 528, the count scale factor κ is used to scale the counts of the non-overlapped pulses. The scaled counts are then further processed to selectively generate volumetric image data based on the spectral characteristics of the photons.

Alternatives are described.

The above embodiment included electronics for counting mode in which detected photons are counted based on the signal from the pixel 118. In another embodiment, electronics for integrating mode are also included in connection with each pixel 118. The integrating electronics integrate the sensor signal from the pixel 118. The spectral decomposition of the integrating electronics can be estimated as a function of Equation 4:

$${I}_{att} = \int {ES}_{0 , I} ( E ) {e}^{- \frac{1}{{E}^{3}} {A}_{1} - {f}_{KN} ( E ) {A}_{2} - {μ}_{Ke}^{*} ( E ) {A}_{3}} d E , \qquad Equation 4$$

where Iₐₜₜ represents the measured x-ray intensity in a pixel. Mₖ can be estimated as a function of Equation 5:

$${M}_{k} = {\int }_{{I}_{k}} {S}_{0 , C} ( E ) {e}^{- l n κ - \frac{1}{{E}^{3}} {A}_{1} - {f}_{KN} ( E ) {A}_{2} - {μ}_{Ke}^{*} ( E ) {A}_{3}} d E . \qquad Equation 5$$

Equations 4 and 5 form a set of non-linear equations from which A₁, A₂, A₃ and κ for each pixel can be determined via Maximum Likelihood estimation or the like. An example of a suitable Maximum Likelihood technique includes a multivariate Gaussian based Maximum Likelihood technique.

A common detector can be employed for both counting and integrating mode. As such, the signal from the pixel 118 is provided to the electronics for counting mode processing and the electronics for integrating mode processing. In this case, the spectral characteristics are substantially the same for counting and integrating mode, and S_{0,I}˜S_{0,C}. Alternatively, different pixel detectors can be used for counting and integrating mode, and S_{0,I}≠S_{0,C}.

FIG. 6 illustrates a suitable counting mode portion for such a system. As depicted, the pixel 118 conveys its output signal to a pulse shaper 604, which generates a pulse having a peak amplitude that is indicative of the energy of the detected photon. The pulse is provided to an energy discriminator 608, and the amplitude of the pulse is energy-discriminated via comparators 612ₖ and thresholds THₖ (k=1−m). The output signals of the comparators are provided to the respective sub-counters 616ₖ (k=1−m) of a counter 620. The sub-counters 616ₖ count the number of rising (or falling) edges in the signals from the comparators 612ₖ.

Gating, or pulse rejection is provided by a pulse shape analyzer 624. The pulse shape analyzer 624 receives the pulse from the pulse shaper 604 and the output of the comparators 612ₖ and determines pulse characteristics indicative of pulse pile-up therefrom. For example, in one instance the pulse shape analyzer 624 determines whether the amplitude of the pulse, after increasing and crossing a threshold, decreases and returns to a baseline level within a preset time interval. The pulse shape analyzer 624 alternatively or additionally determines whether the amplitude of the signal is higher than the baseline or other threshold for more than a maximum time interval. The pulse shape analyzer 624 alternatively or additionally determines whether the received pulse maps to a reference pulse.

The count from the sub-counters 616ₖ provides the measured count for each threshold, or Mₖ. Equations 4 and 5 are used to determine the count scale factor κ using a multivariate Gaussian based Maximum Likelihood technique or a combined Gaussian and Poisson based Maximum Likelihood technique. The count scale factor κ is used to scale the counts from each of the sub-counters 616ₖ. The scaled counts can then be further processed such as energy-binned and reconstructed based on the spectral characteristics.

In an alternative embodiment, the integrating electronics can be omitted. In such instance, the count scale factor κ is determined by via Equation 5 using a Poissonian based Maximum Likelihood technique. Generally, using both counting and integration electronics renders a more accurate count rate relative to using only counting electronics, and using only counting electronics simplifies the complexity relative to using both counting and integrating electronics.

It is to be appreciated that the embodiments described above may be used individually or in combination.

Applications also include luggage inspection, non-destructive testing, medical digital fluoroscopy, mammography, x-ray, as well as other industrial and medical applications.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A apparatus, comprising:
a scale factor determiner that determines a count scale factor based on a measured count of a number detected photons for an energy threshold and an estimated actual count of the number of detected photons, wherein the photons include poly-energetic photons detected by a radiation sensitive detector; and
a count scaler that employs the count scale factor to scale measured counts of detected photons for different energy thresholds.

2. The apparatus of claim 1, wherein the count scale factor determiner generates the count scale factor by dividing the estimated actual count by the measured count.

3. The apparatus of claim 1, wherein the scale factor determiner determines the count scale factor by solving a plurality of simultaneous equations derived from a spectral decomposition of attenuation coefficients.

4. The apparatus of claim 1, further including a counter block that respectively counts detected photons having energy greater than the energy of the different energy thresholds.

5. The apparatus of claim 1, further including a pulse shaper including:
a slow shaper that receives a signal indicative of the detected photon and generates a first pulse therefrom during a first time interval, wherein the first pulse has a peak amplitude indicative of the energy of the detected photon; and
a fast shaper that receives the signal indicative of the detected photon and generates a second pulse therefrom during a second time interval, wherein the second pulse has a peak amplitude indicative of whether the energy of the detected photon exceeds a minimum desired energy, and the second time interval is substantially shorter than the first time interval;
wherein the measured count is determined based on the first pulse and the estimated actual count is determined based on the second pulse.

6. The apparatus of claim 5, further including an energy-discriminator that compares the amplitude of the first pulse to the different energy thresholds to energy-resolve the detected photon based on the thresholds, and compares the amplitude of the second pulse to a minimum threshold set in accordance with the minimum desired energy to determine whether the energy of the detected photon exceeds the minimum desired energy.

7. The apparatus of claim 6, wherein a lowest threshold of the different thresholds and the minimum threshold correspond to a common energy level.

8. The apparatus of claim 5, further including:
a pulse rejecter that generates a signal indicative of a time difference between detected photons; and
a plurality of counters for the different energy thresholds that respectively count detected photons having energy that exceeds a corresponding energy threshold when the time difference indicated by the signal is greater than a preset time difference.

9. The apparatus of claim 5, further including a counter that counts second pulses that exceed the minimum desired energy to determine the estimated actual count of detected photons.

10. The apparatus of claim 1, the scale factor determiner generates the scale factor based on a Maximum Likelihood technique.

11. The apparatus of claim 1, wherein the apparatus forms part of the radiation sensitive detector.

12. The apparatus of claim 1, wherein the apparatus forms part of a computed tomography imaging system.

13. A radiation sensitive detector of an imaging system, comprising:
a counter that counts non-overlapping pulses indicative of detected x-ray photons for a plurality of energy thresholds; and
a count scaler that adjusts the count for each threshold for disregarded overlapping pulses, wherein the count is adjusted based on an estimated count of detected photons having a minimum energy and a measured count of photons based on the count of non-overlapping pulses.

14. The radiation sensitive detector of claim 13, wherein the count scaler includes a scale factor determiner that computes a ratio of the estimated count to the measured count, wherein the count scaler uses the ratio to scale the count for each threshold.

15. The radiation sensitive detector of claim 13, further including a dedicated counting channel including a fast shaper, a comparator, and a counter for estimating the count of detected photons having a minimum energy based on signals indicative of the energy of detected photons.

16. The radiation sensitive detector of claim 13, wherein the scale factor determiner determines the count scale factor based on a spectral decomposition of attenuation coefficients.

17. A method, comprising:
generating first and second pulses for a detected photon, wherein the first pulse has a peak amplitude indicative of the energy of the detected photon, and the second pulse has a peak amplitude indicative of whether the energy of the detected photon exceeds a minimum desired photon energy;
counting the number of times the amplitude of non-overlapping first pulses exceeds a threshold for a plurality of different energy thresholds and disregarding overlapping first pulses, and counting the number of times the amplitude of the second pulses exceeds the minimum desired photon energy;
computing a scale factor by dividing the number of times the second pulses exceed the minimum desired photon energy by the number of times the non-overlapping first pulses exceed a lowest threshold of the plurality of different energy thresholds; and
using the scale factor to adjust the count for each of the plurality of different energy thresholds.

18. The method of claim 17, further including identifying an overlapping first pulse based on the second pulse.

19. The method of claim 17, wherein the first pulse is generated during a first time interval and the second pulse is generated during a second time interval, wherein the second time interval is substantially shorter than the first time interval.

20. The method of claim 19, wherein the second time interval substantially decreases a likelihood of generating overlapping pulses for successive detected photons.
